(19) United States
(12) Patent Application Publication
(10) Pub. No.: US 2011/0133680 A1
(43) Pub. Date: Jun. 9, 2011

(54) FAN SPEED CONTROL METHOD

(76) Inventors: Jeffrey John Girard, Cedar Falls, IA (US); Matthew R. Oliver, Waterloo, IA (US); Paul T. Bruss, Cedar Falls, IA (US)

(21) Appl. No.: 12/633,003

(22) Filed: Dec. 8, 2009

(51) Int. Cl. H02P 1/04

(52) U.S. Cl. 318/461

(57) ABSTRACT

The invention relates to a method of control fan speed in a fan speed control system having a cooling fan driven by a motor, a motor driver for driving the motor at a speed corresponding to a fan speed control signal, and an electronic control unit (ECU) for generating the fan speed control signal. The method includes generating a fan speed control signal and communicating the fan speed control signal to the motor driver so that the motor driver drives the motor at a speed corresponding to the fan speed control signal. If the fan speed control signal is at a level below a noisy fan speed range, then the ECU maintains the fan speed control signal below the noisy fan speed range until the ECU commands a fan speed above the noisy fan speed range. If the fan speed control signal is at a level above the noisy fan speed range, then the ECU maintains the fan speed control signal at a level above the noisy fan speed range until the ECU commands a fan speed below the noisy fan speed range. The method may also include generating a minimum fan speed control signal so that the motor driver drives the motor at a lowest speed that will allow the cooling fan to provide a desired cooling effect.

### FIELD OF THE INVENTION

The present invention relates to a method of controlling the speed of a cooling fan.

### BACKGROUND OF THE INVENTION

Fans are used to direct cooling air to a variety of vehicle components, such engine cooling system components, cab heating, cooling and ventilation units, etc. Such fans produce acoustic noise at an amplitude and frequency which is dependent upon the speed of the fan. The noise produced at the fan is transferred through structural components to an observer, such as the vehicle operator. The noise amplitude may have maximums and minimums which occur at one or more fan speeds due to resonances. Fan speed is typically controlled either manually by operator setting of speed, or automatically in response to a desired temperature set by an operator or by some other requirement. In such a control system, the fan speed may be set to operate at a speed that produces a high level of acoustic noise. This results in operator discomfort and customer dissatisfaction. It would be desirable to control the speed of such a fan so that the fan does not run for long periods of time at speeds which produce noise maximums.

### SUMMARY OF THE INVENTION

Accordingly, an object of this invention is to provide a method for controlling the speed of a fan so that the fan does not run for long periods of time at speeds which produce noise maximums.

This and other objects are achieved by the present invention, wherein a fan speed control system includes a cooling fan driven by a motor, a motor driver for driving the motor at a speed corresponding to a fan speed control signal, and an electronic control unit (ECU) for generating the fan speed control signal as a function operator and/or sensor inputs. The method includes generating a fan speed control signal and communicating the fan speed control signal to the motor driver so that the motor driver drives the motor at a speed corresponding to the fan speed control signal. If the fan speed control signal is at a level below a noisy fan speed range, then the ECU maintains the fan speed control signal below the noisy fan speed range until the ECU commands a fan speed above the noisy fan speed range. If the fan speed control signal is at a level above the noisy fan speed range, then the ECU maintains the fan speed control signal at a level above the noisy fan speed range until the ECU commands a fan speed below the noisy fan speed range. The method may also include generating a minimum fan speed control signal so that the motor driver drives the motor at a lowest speed that will allow the cooling fan to provide a desired cooling effect.

### BRIEF DESCRIPTION OF THE DRAWINGS

FIG. 1 is a simplified schematic diagram of a fan speed control system embodying the present invention;

FIG. 2 is a flow chart representing an algorithm executed by the ECU of FIG. 1.

### DESCRIPTION OF THE PREFERRED EMBODIMENT

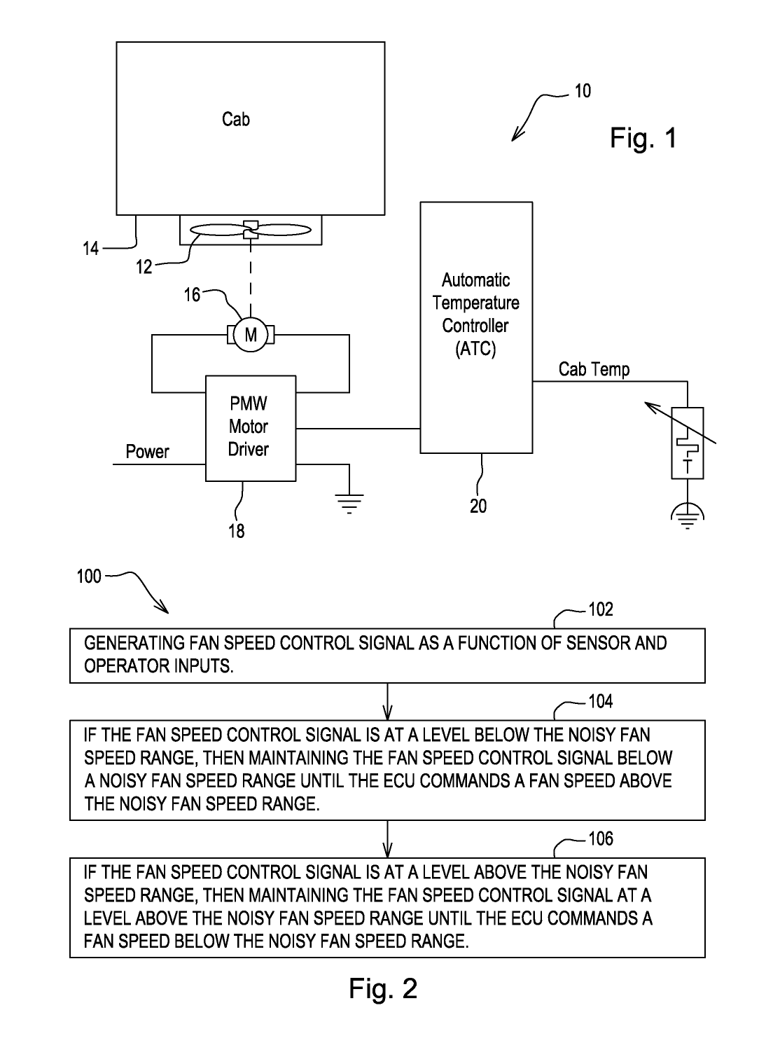

Referring to FIG. 1, a fan speed control system 10 includes a fan 12 which provides cooling air flow to a unit such as a vehicle cab 14. The fan 12 is driven by an electric motor 16 which is driven by a conventional pulse width modulation motor driver 18. The motor driver 18 controls the speed of the motor 16 in response to speed control signals generated by electronic control unit ECU 20. ECU 20 receives a cab temperature signal from cab temperature sensor 22. Preferably, the ECU includes a selectable Auto mode in which fan speed is automatically controlled, and a selectable Manual mode in which fan speed is controlled as a function of the setting of an operator controlled input device (not shown).

The ECU 20 executes an algorithm 100 represented by FIG. 2. The conversion of the above flow chart into a standard language for implementing the algorithm described by the flow chart in a digital computer or microprocessor, will be evident to one with ordinary skill in the art. The ECU 20 includes a memory 22 in which is stored data pertaining to a noise versus speed characteristics of the fan 12. For example, the fan 12 may produce a maximum amount of acoustic noise at a speed of about 1300 rpm. Also stored in the memory 22 is a noisy fan speed range which contains the maximum noise speed, such as from approximately 1200 to 1400 rpm.

At step 102 the ECU 20 executes a known basic fan speed control algorithm which generates a fan speed control signal as a function of the temperature sensed by sensor 22 and operator inputs (not shown). Preferably, this basic algorithm attempts to run the fan motor 16 at the lowest speed which will achieve the desired cab temperature.

According to the present invention, in addition, at step 104, if the fan speed control signal is at a level below the noisy fan speed range, then the ECU 20 maintains the fan speed control signal below the noisy fan speed range until the ECU 20 commands a fan speed above the noisy fan speed range. When such a higher fan speed is commanded, the ECU 20 will generate fan speed control signals which will rapidly cause the speed of the fan motor 16 to increase to a fan speed faster than the noisy fan speed range.

Also, at step 106, if the fan speed control signal is at a level above the noisy fan speed range, then the ECU 20 maintains the fan speed control signal at a level above the noisy fan speed range until the ECU 20 commands a fan speed below the noisy fan speed range. When such a lower fan speed is commanded, the ECU 20 will generate fan speed control signals which will rapidly cause the speed of the fan motor 16 to decrease to a fan speed slower than the noisy fan speed range. With this method, the fan speed will not remain for long periods at speeds at or near the maximum noise speed. Preferably, this method operates in both the Auto and Manual modes of the ECU 20. With this method, Noise levels would be reduced, and the operator environment would be more pleasant, causing improved customer satisfaction.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

We claim:

1. In a fan speed control system having a cooling fan driven by a motor, a motor driver for driving the motor at a speed corresponding to a fan speed control signal, and an electronic control unit (ECU) for generating the fan speed control signal, a method of controlling fan speed comprising:
generating a fan speed control signal and communicating the fan speed control signal to the motor driver so that the motor driver drives the motor at a speed corresponding to the fan speed control signal;
if the fan speed control signal is at a level below a noisy fan speed range, then maintaining the fan speed control signal below the noisy fan speed range until the ECU commands a fan speed above the noisy fan speed range; and
if the fan speed control signal is at a level above the noisy fan speed range, then maintaining the fan speed control signal at a level above the noisy fan speed range until the ECU commands a fan speed below the noisy fan speed range.

2. The method of claim 1, further comprising:
generating a minimum fan speed control signal so that the motor driver drives the motor at a lowest speed that will allow the cooling fan to provide a desired cooling effect.

3. The method of claim 1, further comprising:
determining a noisy fan speed at which the fan produces a significant amount of acoustic noise;
determining a noisy fan speed range which contains the noisy fan speed; and
storing said noisy fan speed range in a memory of the ECU.
